(19) United States
(12) Patent Application Publication
(10) Pub. No.: US 2006/0026555 A1
(43) Pub. Date: Feb. 2, 2006

(54) Method and apparatus to support multiple hierarchical architectures

(75) Inventors: Barry Alan Feigenbaum, Austin, TX (US); Michael A. Squillace, Austin, TX (US)

Correspondence Address: Gregory W. Carr, 670 Founders Square, 900 Jackson Street, Dallas, TX, 75202, US

(73) Assignee: International Business Machines Corporation, Armonk, NY (US)

(21) Appl. No.: 10/889,781

(22) Filed: Jul. 13, 2004

(51) Int. Cl. G06F 9/44

(52) U.S. Cl. 717/104; 717/106

(57) ABSTRACT

An apparatus, a method, and a computer program are provided to enable an engine to employ a plurality of architectures in building and rendering a hierarchical structure, such as a Graphical User Interface (GUI). Currently, engines are typically hard coded to employ a single architecture, thus, requiring the engine to be architecturally specific. However, with the variety of architectures that exist and that are in use, it is useful to have an engine that can interact with many architectures. Therefore, an engine is provided with an interface that allows for interaction with many architectures while maintaining an engine that is architecturally neutral.

### CROSS-REFERENCED APPLICATIONS

This application relates to co-pending U.S. patent application entitled “Defining Hierarchical Structures with Markup Languages and Reflection” (Docket No. AUS920040410US1), filed on ______, which is hereby incorporated by reference.

### FIELD OF THE INVENTION

The present invention relates generally to building and rendering hierarchical structure, and more particularly, to integrating structure classes over a variety of frameworks.

### DESCRIPTION OF THE RELATED ART

In the software industry, the use of hierarchical structures, such as Graphical User Interfaces (GUIs) for applications is commonplace. Specifically, GUIs are utilized because of their particular user-friendliness and because of increasing usage of computer networks, such as the Internet. Creation of the GUIs, though, can be complicated task. The creation of GUIs can be further complicated by desired characteristics, such as portability or look-and-feel of the GUI.

Referring to FIG. 1 of the drawings, the reference numeral 100 generally designates a flow chart depicting conventional architectural support that is hard coded for a particular framework. When an engine encounters a component in step 102, the engine cannot utilize the component without a definition. For example, if “Panel” is encountered, an engine will not be able to build or render “Panel” without a definition. Therefore, in step 104, a hardwired framework definition from any number of different frameworks, such as GNOME or SWT, is retrieved. Once retrieved, the architecture analyzes the component in step 106 to determine if the component is correct. In other words, a definition may be employed, but the number or characteristics of input data may be incorrect. Thus, the engine would analyze the input data to determine if the correct definition is utilized. If the component is not correct, then in step 108, a null value is returned indicating an error has occurred. However, if the component is correct, then in step 110 the definition is determined and the requisite values are returned.

Traditionally, though, when building and rendering hierarchical structures, such as GUIs, there had to be specific class definitions for each class structure. Essentially, a “switch” or “case” group is provided where the code is specific to support each architecture. For example, a switch group can be provided for SWT, GNOME, or AWT. Typically, the application itself is coded to one architecture such as Swing or SWT; it is unlikely that an application or network of applications would contain more than one architecture or framework. Having such hardwired code, though, can be problematic. If another architecture is desired, changes to the application code are required. Additionally, a redistribution of the application may also be necessary.

Therefore, there is a need for a method and/or apparatus for building and rendering hierarchical structures that at least addresses some of the problems associated with conventional methods for building and rendering hierarchical structures.

### SUMMARY OF THE INVENTION

The present invention provides a method, an apparatus, and a computer program for supporting multiple architectures. To build and render a hierarchical structure, a structure document is first parsed for components by an architecturally neutral engine. Once the components have been determined, an interface is used to determining definitions associated with the components. The interface allows for access to multiple architectures so that an engine can effectively interact with any or all available architectures.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a flow chart depicting conventional architectural support;

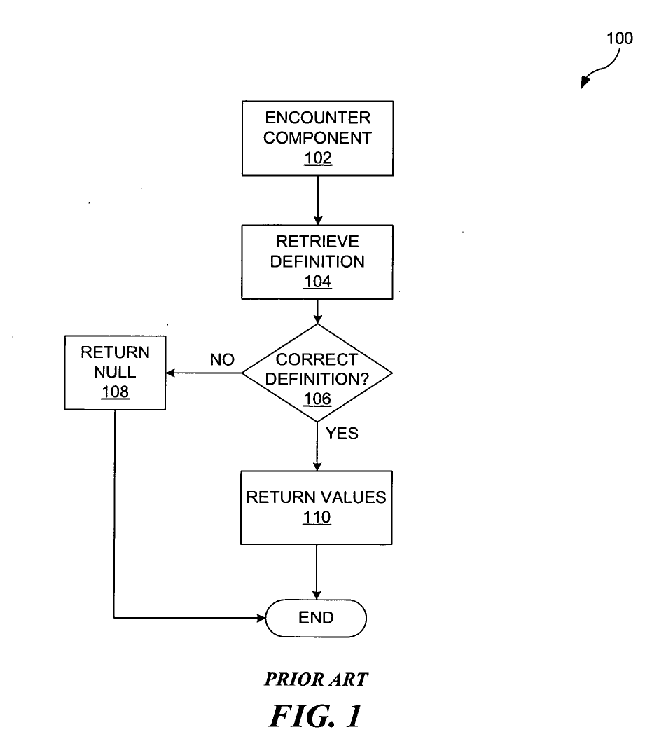

FIG. 2 is a block diagram depicting a computer system that incorporates integrated architectural support; and

FIG. 3 is a flow chart depicting an integrated architectural support.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combinations thereof. In a preferred embodiment, however, the functions are performed by a processor such as a computer or an electronic data processor in accordance with code such as computer program code, software, and/or integrated circuits that are coded to perform such functions, unless indicated otherwise.

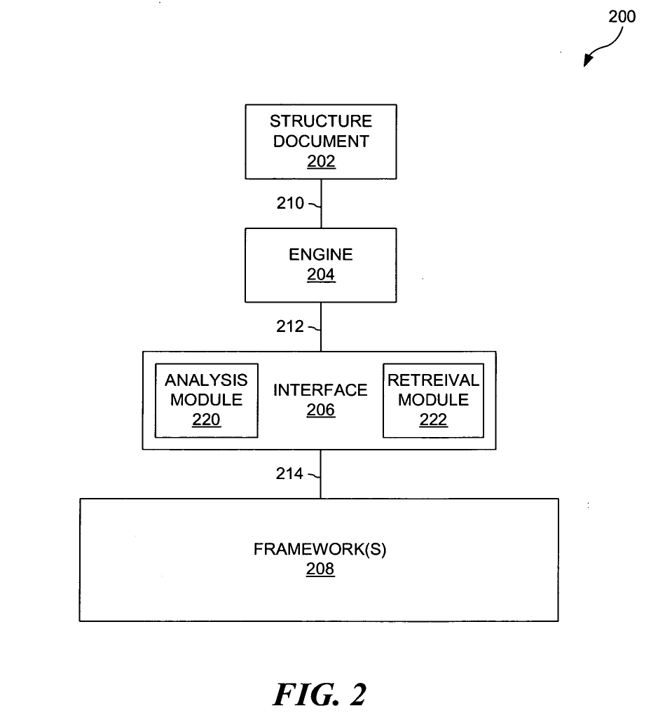

Referring to FIG. 2 of the drawings, the reference numeral 200 generally designates a computer system that incorporates integrated architectural support. The computer system comprises a structure document 202, an engine 204, an interface 206, and framework(s) 208.

When building and rendering a hierarchical structure, such as a GUI, a structural document 202 is first composed. The structural document 202 typically comprises the precise layout for the hierarchical structure that is to be built and rendered. There are a variety of document types that can be utilized. For example, an Extended Markup Language (XML) document can be employed as a structural document. An example of an XML document that can define a GUI in Java® Swing, available from Sun Microsystems, Inc., 901 San Antonio Road, Palo Alto, Calif. 94303, is as follows:

```
<?xml version=“1.0”?>
<rib:gui
  xmlns:rib=“com.ibm.wac.rgb”
  rib:scriptlang=“jython”
  rib:architecture=“swing”
>
  <rib:scripts>
    import javax.accessibility.AccessibleRelation as AccRelation
  </rib:scripts>
  <rib:aliases>
    <rib:alias
      rib:name=“BorderLayout”
      rib:value=“java.awt.BorderLayout”
    />
    <rib:alias
      rib:name=“acName”
      rib:value=“!getAccessibleContext!setAccessibleName”
    />
  </rib:aliases>
  <rib:objects>
    <Dimension rib:id=“screenDim”>300, 150</Dimension>
    <Color rib:id=“bkgdColor”>224, 224, 255</Color>
  </rib:objects>
  <rib:components>
    <Frame rib:id=“mainFrame”
      size=“@screenDim”
      title=“RGB -- Sample 1”
      background=“@bkgdColor”
    >
      <getRootPane>
        <defaultButton button=“@clearButton”/>
      </getRootPane>
      <addWindowFocusListener><windowFocusGained>
        nameField.requestFocus( )
      </windowFocusGained></addWindowFocusListener>
      <getContentPane>
        <Panel rib:id=“infoPanel” rib:constraints=“NORTH”
          layout=“%BorderLayout”
        >
          <Box rib:constraints=“NORTH”>
            swing.BoxLayout.X_AXIS
            <horizontalGlue/>
            <Label rib:id=“nameLabel”
              text=“Name:”
              labelFor=“@nameField”
              horizontalAlignment=“RIGHT”
            />
            <horizontalStrut width=“4”/>
            <TextField rib:id=“nameField”
              columns=“20”
              toolTipText=“Enter your full name”
            focusAccelerator=“n”
            >
              <acName name=“name input field”/>
              <acRelation rel=“{AccRelation(AccRelation.
LABELED_BY, nameLabel)}”/>
            </TextField>
            <horizontalStrut width=“8”/>
            <Label rib:id=“emailLabel”
              text=“Email:”
              labelFor=“@emailField”
              horizontalAlignment=“RIGHT”
            />
            <horizontalStrut width=“4”/>
            <TextField rib:id=“emailField”
              columns=“20”
              toolTipText=“Enter your email address”
            >
              <acName name=‘email input field’/>
              <acRelation rel=“{AccRelation(AccRelation.
LABELED_BY, emailLabel)}”/>
            </TextField>
            <horizontalGlue/>
          </Box>
          <Box rib:constraints=“SOUTH”>
            swing.BoxLayout.X_AXIS
            <horizontalGlue/>
            <Button rib:id=“clearButton” text=“Clear”
              toolTipText=“Clear the form fields”>
              <mnemonic>
                awt.event.KeyEvent.VK_R
              </mnemonic>
              <addActionListener>
                nameField.text = “”
                emailField.text = “”
              </addActionListener>
            </Button>
            <horizontalStrut width=“6”/>
            <Button rib:id=“exitButton” text=“Exit”
              toolTipText=“Exit the app”>
              <mnemonic>
                awt.event.KeyEvent.VK_X
              </mnemonic>
              <addActionListener>
                confirm = \
                  swing.JOptionPane.showConfirmDialog(
                  mainFrame,
                  “Confirm Exit”,
                  “Confirm Exit Dialog”,
                  swing.JOptionPane.YES_NO_OPTION
                  )
                if confirm == swing.JOptionPane.YES_OPTION:
                  lang.System.exit(0)
              </addActionListener>
            </Button>
            <horizontalGlue/>
          </Box>
        </Panel>
      </getContentPane>
    </Frame>
  </rib:components>
</rib:gui>
```

Once constructed, the structure document 202 is communicated to the engine 204, such as the IBM® Reflexive User Interface Builder (RIB), which is available from International Business Machines, New Orchard Road Armonk, N.Y. 10504, that begins the process of building and rendering a hierarchical structure. The structure document 202 is communicated to the engine 204 through a first communication channel 210. While parsing the structured document 202 for components, the engine 204 can utilize an interface 206 to define classes of components in a variety of frameworks 208, such as SWT or Java® Swing. The engine 204 communicates with the interface 206 through a second communication channel 212, while the interface 206 communicates with the framework(s) 208 through a third communication channel 214. The interface 206 internally employs a analysis module 220 and a retrieval module 222 to effectively determine and retrieve the accurate definition contained within the framework(s) 208.

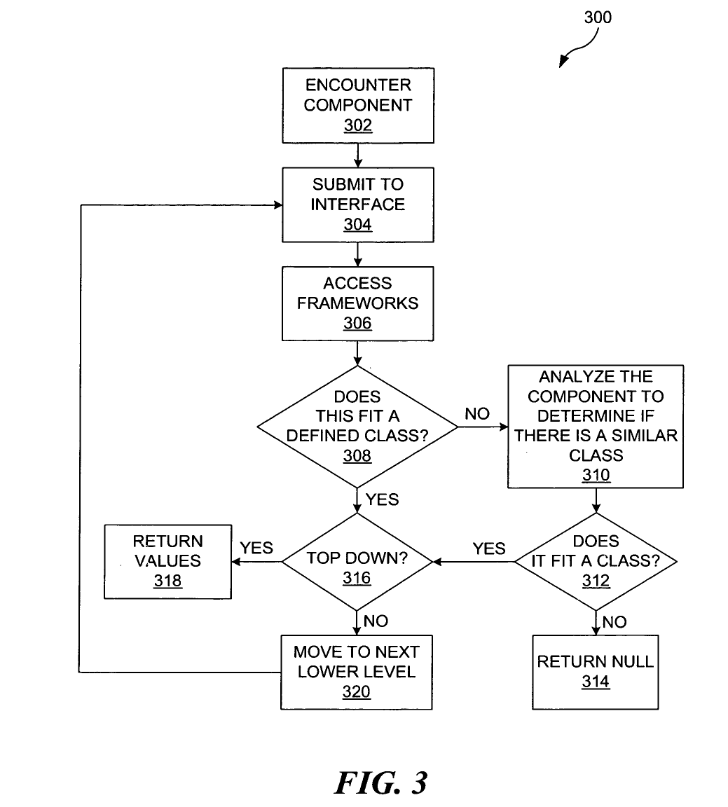

Referring to FIG. 3 of the drawings, the reference numeral 300 generally designates a flow chart depicting an integrated architectural support. In order for the integrated architectural support to function with a variety of frameworks, such as SWT or GNOME, an interface, such as the interface 206, is employed that allows for common characteristic structural constraints utilized by the different frameworks. For example, the manner in which the component are linked and traversed, the controls that serve as top level or root components, and the manner of rendering can all be defined in the interface. An example of an interface with Java® Swing is as follows:

```
public class SwingArchitecture extends BaseArchitecture
{
    private static final String ARCH_TYPE = “swing”;
    private static final Set IGNORABLES = new HashSet( );
    private static final String[ ] PACKAGE_LIST = new String[ ]
        {“java.lang”, “java.awt”, “Java.awt.event”, “javax.swing”};
    static {
        IGNORABLES.add(javax.swing.CellRendererPane.class);
    }
    /**
      * create a new SwingArchitecture
      */
    public SwingArchitecture ( ) {
    }
    /** {@inheritDoc} */
    public String getArchitectureType ( ) {
        return ARCH_TYPE;
    }
    /**
      * {@inheritDoc}
      * <p>Alternate method names returned include:
      * <p><ul>
      * <li>‘set’ + rootName
      * <li>‘add’ + rootName
      * <li>‘create’ + rootName
      * </ul>
      *
      * <p>First char of rootName is converted to upper case
      */
    public String[ ] getAlternateMethodNames (String rootName) {
        String[ ] names = new String[3];
        names[0] = “set” + RgbUtils.firstCharToUpper(rootName);
        names[1] = “add” + RgbUtils.firstCharToUpper(rootName);
        names[2] = “create” + RgbUtils.firstCharToupper(rootName);
        return names;
    }
    /**
      * {@inheritDoc}
      * @see “com/ibm/wac/rgb/engine/swing_aliases.properties”
      */
    public InputStream getAliasesStream ( )
    {
        InputStream is = null;
        try {
            is = ClassLoader.getSystemClassLoader( ).getResourceAsStream(
                ALIASES_PROPERTIES_FILE_DIR + ARCH_TYPE +
ALIASES_PROPERTIES_FILE_SUFFIX
            );
        } catch (Exception e) {
            RgbUtils.println(RgbUtils.ERRORS, e.getMessage( ));
            System.exit(0);
        }
        return is;
    }
    /** {@inheritDoc} */
    public String getDefaultAliasPrefix ( ) {
        return “javax.swing”;
    }
    /**
      * {@inheritDoc}
      * <p>Includes packages:
      * <p><ul>
      * <li> java.lang
      * <li> java.awt
      * <li> java.awt.event
      * <li> javax.swing
      * </ul>
      */
    public String[ ] getInitPackages ( ) {
        return PACKAGE_LIST;
    }
    /**
      * returns <code>true</code> if component is an instance of
<code>java.awt.Component</code>
      */
    public boolean isLinkable (Object comp) {
        return comp instanceof Component;
    }
    /** {@inheritDoc} */
    public boolean isIgnorable (Object comp) {
        return IGNORABLES.contains(comp.getClass( ))
            || comp.getClass( ).getName( ).indexOf(“.metal.”) != −1;
    }
    /**
      * return <code>false</code> since Swing components may be created
and
      * added to GUIs independently
      *
      * @return <code>false</code>
      */
    public boolean performsLinkOnCreation ( ) {
        return false;
    }
    /**
      * return <code>false</code> since Swing GUIs are typically (and
      * most effectively) bottom-up
      *
      * @return <code>false</code>
      */
    public boolean isTopDown ( ) {
        return false;
    }
    /**
      * An object must be an instance of a class that inherits from
<code>javax.swing.RootPaneContainer</code>
      * and from <code>java.awt.Window</code> to serve as a top-level
component in a Swing GUI
      *
      * @param c -- class to be tested
      * @return <code>true</code> if the given class inherits
                        * from <code>java.awt.Window</code> and from
<code>javax.swing.RootPaneContainer</code>
      */
    public boolean isGuiRootType (Class c) {
        return (Window.class.isAssignableFrom(c) &&
RootPaneContainer.class.isAssignableFrom(c));
    }
    /**
      * An object must be an instance of a class that inherits from
<code>javax.swing.RootPaneContainer</code>
      * and from <code>java.awt.Window</code> to serve as a top-level
component in a Swing GUI
      *
      * @param o -- object to be tested
      * @return <code>true</code> if the given object is an instance of a
class that inherits
      * from<code>java.awt.Window</code> and from
<code>javax.swing.RootPaneContainer</code>
      */
    public boolean isGuiRoot (Object o) {
        return (o instanceof Window && o instanceof RootPaneContainer);
    }
    /**
      * returns a <code>javax.swing.JFrame</code> with title
      * <code>DEFAULT_WINDOW_TITLE</code>
      *
      * @return JFrame in case that no root component of type
<code>java.awt.Window</code> is specified
      */
    public Object getDefaultGuiRoot ( ) {
        return new JFrame(DEFAULT_WINDOW_TITLE);
    }
    /** {@inheritDoc} */
    public EventDispatcher getEventDispatcher (Map eventMap, Object
codeReader) {
        return codeReader != null
            ? new com.ibm.wac.rgb.codewrap.SwingCodeWrapper(eventMap,
(CodeInterpreter) codeReader)
            : super.getEventDispatcher(eventMap, null);
    }
    /**
      * add the given child component to the parent component using
      * <code>java.awt.Container.add(java.awt.Component)</code> method or
      *  <code>java.awt.Container.add(java.awt.Component,
java.lang.Object)</code> method if constraints are supplied
      *
      * @param parent -- should be an instance of java.awt.Container
      * @param child -- should be an instance of java.awt.Component
      * @param constraints -- constraints object (if any)
      */
    public Object link (Object parent, Object child, Parameter[ ]
constraints)
    {
        try {
            Component component = (Component) child;
            Container container = (Container) parent;
            RgbUtils.println(RgbUtils.PROCESS_INFO, “Adding
”+component.getClass( ).getName( )+“ to ”+parent.getClass( ).getName( ));
            if (constraints != null && constraints.length == 1) {
                Object constraintsObj = resolveConstraints(
                    container.getLayout( ), constraints[0]);
                RgbUtils.println(RgbUtils.ALL, “Using constraints ” +
constraintsObj);
                container.add(component, constraintsObj);
            } else {
                container.add(component);
            }
        } catch (Exception e) {
            RgbUtils.println(RgbUtils.ERRORS, “Could not add object of
type ” + child.getClass( ).getName( ) + “ to object of type ” +
parent.getClass( ).getName( ));
            RgbUtils.println(RgbUtils.ERRORS, e.getMessage( ));
            child = null;
            e.printStackTrace( );
        }
        return child;
    } // link
    /** @return <code>null</code> */
    public Object link (Object parent, Class childCls,
                    Parameter[ ] ctorParams, Parameter[ ] linkParams) {
        return null;
    }
    /**
      * render the specified component by calling its
<code>setVisible(boolean)</code> method;
      * component should be a top-level object as designated by
<code>isTopLevelObject(Object)</code>
      *
      * @param component -- component to be rendered
      */
    public void render (Object component)
    {
        if (component != null) {
            Component renderable = null;
            if (isGuiRoot(component)) {
                renderable = (Component) component;
            } else {
                renderable = (Component) getDefaultGuiRoot( );
((RootPaneContainer)renderable).getContentPane( ).add((Component)
component);
            }
            renderable.setVisible(true);
            printTree(renderable, (PrintWriter)null);
        }
    } // render
    /** {@inheritDoc} */
    public void printTree(Object component, PrintWriter pw) {
        printTree(component,
        pw == null ? new PrintWriter(System.out, true) : pw, 0);
    }
    private void printTree(Object c, PrintWriter pw, int indent)
    {
        Component component = (Component) c;
        for (int i = 0; i < indent; i ++) {
            pw.print(“ ”);
        }
        pw.print(“” + indent + “: ”);
        String name = component.getName( );
        try {
            pw.print(component.getClass( ).getName( ) + ‘[’ +
                                (name != null ? name : “<none>”));
            pw.println(“,(” +
(int)component.getLocationOnScreen( ).getX( ) + ‘,’ +
(int)component.getLocationOnScreen( ).getY( ) + “),” +
                                (int)component.getSize( ).getWidth( ) + ‘x’
+ (int)component.getSize( ).getHeight( ) +
                                ‘]’);
        } catch (java.awt.IllegalComponentStateException e) {
            pw.println(“”);
        }
        if (component instanceof RootPaneContainer) {
            printTree(((RootPaneContainer) component).getContentPane( ),
pw, indent + 1);
        } else if (component instanceof JComponent) {
            Component[ ] ca = ((JComponent) component).getComponents( );
            for (int i = 0; i < ca.length; i++) {
                printTree(ca[i], pw, indent + 1);
            }
        }
    } // printTree
    private Object resolveConstraints (LayoutManager mgr, Parameter
constraints)
    {
        Object constraintsObj = null;
        if (constraints.isScriptCode( ) || constraints.isReferenceId( )) {
            constraintsObj = constraints.resolve(Object.class);
            if (constraintsObj == null) {
                RgbUtils.println(RgbUtils.ERRORS, “Unrecognized
constraints object: ” + constraints);
            }
        } else {
            constraintsObj = constraints.resolve(Object.class, mgr);
            if (constraintsObj == null) {
                RgbUtils.println(RgbUtils.ERRORS, “Could not identify
field ” + constraints + “ for object of type ” +
mgr.getClass( ).getName( ));
            }
        }
        return constraintsObj;
    } // resolveConstraints
} // SwingArchitecture
```

Once an engine, such as RIB, begins to traverse a document to build and render a hierarchical structure, such as a GUI, the engine first encounters components in step 302. These components can vary in type. For example, “Frame” can be defined as a component in an Extended Markup Language (XML) document, which is defined as follows:

```
<Frame rib:id=“mainFrame”
      size=“@screenDim”
      title=“RGB -- Sample 1”
      background=“@bkgdColor”
>
```

Within each component, too, there can be a set of attributes that are interpreted as properties of the component.

Once encountered, the component is submitted to the interface in step 304. By submitting the component to the interface, the interface can define and set parameters for building and rendering the component. Access to the framework, though, must be provided, which is accomplished in step 306. For example, in the interface for Java® Swing, the interface defines the following:
import javax.swing.JFrame;
   By importing “javax.swing.JFrame,” the interface allows access to definitions contained within “javax.swing.JFrame.”

However, simply submitting the encountered component is not sufficient. A determination is made as to whether the term utilized in the component fits a defined class in step 308. For example, if the component is named “Frame,” the component may not necessarily be defined. If there is no class definition associated with the component name, the interface will then perform an analysis to determine if there is a method or field definition identical or similar to the component name in step 310. The analysis can comprise a variety of techniques. For example, name reconstruction can be employed where the component name, such as “Frame,” is prepended with other words such as “create” that would yield a component name of “createFrame” which may be defined. During the process of determining whether the component name is defined, further determinations are made to see if there is a class definition in step 312. Additionally, the component can be measured based on its attributes. If a definition cannot be found, then a null is returned in step 314.

Once a class definition is found, however, other processes are forwarded. In step 316, a determination is made as to whether the framework is a top-down framework. The difference between a top-down and a bottom-up framework is that a bottom-up component requires that a component be built and rendered from the lowest level child component contained within a parent component, while a top-down framework can build and render each parent component downward toward the lowest level child component. Java® Swing is an example of a bottom-up framework, and SWT is an example of a top-down framework. If the framework is a top-down framework, then the values required for the defined component are returned in step 318. However, if the framework is not a top-down framework, thus implying a bottom-up framework, the engine moves to next lower child component in step 320.

By utilizing the integrated architecture, an engine can therefore be framework neutral. In other words, the engine does not necessarily have any definitions, sub-routines, or other hard coded implementations that correspond to a specific architecture or framework. The engine is allowed to control how a hierarchical structure, such as a GUI, is constructed and rendered. Hence, support can be extended to a variety of new and different frameworks without structural changes to the engine, such as RIB. The flexibility of the engine can then be more easily implemented for any and all frameworks.

It is understood that the present invention can take many forms and embodiments. Accordingly, several variations may be made in the foregoing without departing from the spirit or the scope of the invention. The capabilities outlined herein allow for the possibility of a variety of programming models. This disclosure should not be read as preferring any particular programming model, but is instead directed to the underlying mechanisms on which these programming models can be built.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by c(;hose skilled in the art based upon a review of the foregoing description of preferred embodiments. Accordingly, it is appropriate that the appended claims be construed broadly and in a manner consistent with the scope of the invention.

1. A method for supporting multiple architectures, comprising:
parsing at least one structure document for at least one component with an architecturally neutral engine; and
determining at least one definition of the at least one component with an interface that is at least configured to access a plurality of architectures.

2. The method of claim 1, wherein the step of determining further comprises analyzing the at least one component to determine if the at least one definition exists.

3. The method of claim 2, wherein the step of analyzing further comprises modifying a name of the at least one component to determine if the at least one definition exists.

4. The method of claim 2, wherein the step of analyzing further comprises analyzing input data to determine if the at least one definition exists.

5. The method of claim 1, wherein the step of determining at least one definition further comprises:
accessing at least one architecture of the plurality of architectures;
determining if the at least one definition exists in the at least one architecture; and
if the at least one definition exists, determining if the at least one architecture is a top-down architecture.

6. The method of claim 5, wherein the method further comprises employing the at least one definition if the at least one architecture is a top-down architecture.

7. The method of claim 5, wherein the method further comprises parsing the at least one component for at least one child component if the at least one architecture is not a top-down architecture.

8. A computer program product for supporting multiple architectures, the computer program product having a medium with a computer program embodied thereon, the computer program comprising:
computer code for parsing at least one structure document for at least one component with an architecturally neutral engine; and
computer code for determining at least one definition of the at least one component with an interface that is at least configured to access a plurality of architectures.

9. The computer program product of claim 8, wherein the computer code for determining further comprises computer code for analyzing the at least one component to determine if the at least one definition exists.

10. The computer program product of claim 9, wherein the computer code for analyzing further comprises computer code for modifying a name of the at least one component to determine if the at least one definition exists.

11. The computer program product of claim 9, wherein the computer code for analyzing further comprises computer code for analyzing input data to determine if the at least one definition exists.

12. The computer program product of claim 8, wherein the computer code for determining at least one definition further comprises:
computer code for accessing at least one architecture of the plurality of architectures;
computer code for determining if the at least one definition exists in the at least one architecture; and
if the at least one definition exists, computer code for determining if the at least one architecture is a top-down architecture.

13. The computer program product of claim 12, wherein the method further comprises computer code for employing the at least one definition if the at least one architecture is a top-down architecture.

14. The computer program product of claim 12, wherein the computer program product further comprises computer code for parsing the at least one component for at least one child component if the at least one architecture is not a top-down architecture.

15. An apparatus for supporting multiple architectures, comprising:
at least one engine for parsing at least one structure document for at least one component;
a plurality of architectures, wherein each architecture of the plurality is at least configured to contain a plurality of definitions; and
an interface for retrieving at least one definition from at least one architecture of the plurality of architectures based on the at least one component.

16. The apparatus of claim 1, wherein the interface further comprises:
an analysis module for analyzing the at least one component to locate the at least one definition; and
a retrieval module to retrieve the at least one definition.
